(19) United States
(12) Patent Application Publication
(10) Pub. No.: US 2021/0019846 A1
(43) Pub. Date: Jan. 21, 2021

(54) SYSTEMS AND METHODS FOR REAL-ESTATE SERVICE MANAGEMENT

(71) Applicant: My Home Hub LLC, Woodinville, WA (US)

(72) Inventors: Mohammad Kaddoura, Woodinville, WA (US); Naushad Ali, Woodinville, WA (US)

(21) Appl. No.: 16/930,165

(22) Filed: Jul. 15, 2020

Related U.S. Application Data
(60) Provisional application No. 62/874,436, filed on Jul. 15, 2019.
(60) Provisional application No. 62/874,441, filed on Jul. 15, 2019.

(51) Int. Cl. G06Q 50/16; G06Q 30/06; G06F 9/54

(52) U.S. Cl. CPC G06Q 50/16; G06F 9/54; G06Q 30/0631

(57) ABSTRACT

Various embodiments of the present technology provide an integrated platform that automates task generation for real-estate service management. The system and method are useful for buyers, agents, realtors, vendors, and financial institutions involved in the transaction and maintenance of a real-estate property. More specifically, some embodiments of the present technology relate to platforms for sharing, modifying, automating, and scheduling real-estate content (e.g., contracts, documents, articles, etc.) In accordance with various embodiments, the cloud-based property service platform can extract data from various cloud databases such as 3^{rd} party, vendors, and clients and generate tasks for each user. Documents shared between various users initiate a parallel partition of tasks that are ordered based on the user roles and intermittent process (e.g., reviewing, updating, processing, etc.) completed by other parties (e.g., lenders, other agents, etc.). Additionally, EZ tasks can compile tasks and communications upon approval of suggestions to the user. The real-estate service platform further utilizes a CRM engine that may enhance a user connectivity. Touch and swipe gestures can select, assign users, and share content such as articles.

### CROSS-REFERENCE TO RELATED APPLICATIONS

The present application claims priority to U.S. Provisional Application No. 62/874,436 filed Jul. 15, 2019 titled “Systems and Methods for Real-Estate Service Management” and U.S. Provisional Application No. 62/874,441 filed Jul. 15, 2019 titled “Graphical User Interfaces And Other Systems For Real-Estate Service Management” both of which are incorporated herein by reference in its entirety for all purposes.

### TECHNICAL FIELD

Various embodiments of the present technology generally relate to systems and methods for real-estate service management. More specifically, some embodiments of the present technology relate to platforms for sharing, modifying, automating, and scheduling content based on metadata of both the user and user affiliated content.

### BACKGROUND

Home buyers are confronted with a variety of unfamiliar tasks during the purchase of a new home. As a result, home buyers have to rely on real-estate agents to guide home buyers through these unfamiliar tasks. However, the agents themselves may have a high volume of clients that need to be managed in addition to ensuring the proper coordination between various lenders, realtors, and other agents for the home purchase to successfully close. Consequently, both agents and buyers are confronted with multiple tasks that need to be completed timely. Ensuring these tasks are completed timely is difficult for even the most experienced agent. Novice agents who do not have as much experience handling real-estate transactions face even more difficulty. Unfortunately, few useful resources exist for addressing these challenges facing home buyers and agents.

### BRIEF DESCRIPTION OF THE DRAWINGS

Embodiments of the present technology will be described and explained through the use of the accompanying drawings in which:

FIG. 1 illustrates an example of an integrated environment in which some embodiments of the present technology may be utilized;

FIG. 2 illustrates data flow between various components of a property service platform that may be used in one or more embodiments of the present technology;

FIG. 3 illustrates a set of components that may be used within a property service platform according to one or more embodiments of the present technology;

FIG. 4 is a flowchart illustrating a set of operations for managing a customized user experience according to one or more embodiments of the present technology;

FIG. 5 is a flowchart illustrating a set of operations for operating for generating custom recommendations and user experiences within a property service platform in accordance with some embodiments of the present technology;

FIG. 6 is a flowchart illustrating a set of operations for automatically partitioning tasks driven by task queries with database inputs according to some embodiments of the present technology;

FIG. 7 is a sequence diagram illustrating an example of the data flow between various components of a property service platform according to various embodiments of the present technology;

FIG. 8 is a flowchart illustrating a set of operations for presenting tasks in a user interface driven by task queries with database inputs according to some embodiments of the present technology;

FIG. 9 is a flowchart illustrating a set of operations for automatically surfacing recommendations to users based on home property details and home features and service expectancies in accordance with various embodiments of the present technology;

FIG. 10 is a flowchart illustrating a set of operations for providing expert support for a user in accordance with one or more embodiments of the present technology;

FIG. 11 is a flowchart illustrating a set of operations for automatically surfacing recommendations to users based on triggers found in client user timetables in accordance with various embodiments of the present technology;

FIG. 12 is a diagram illustrating the network connectivity of a real-estate service management system according to various embodiments of the present technology;

FIGS. 13A, 13B, 13C, 13D, and 13E are examples of graphical user interfaces that may be used in accordance with one or more embodiments of the present technology;

FIGS. 14A and 14B are examples of graphical user interfaces on a mobile device that may be used in accordance with one or more embodiments of the present technology;

FIGS. 15A, 15B, and 15C are examples of graphical user interfaces on a mobile device that may be used in accordance with one or more embodiments of the present technology;

FIGS. 16A, 16B, and 16C are examples of graphical user interfaces on a mobile device that may be used in accordance with one or more embodiments of the present technology;

FIGS. 17A, 17B, and 17C are examples of sequential graphical user interfaces on a mobile device that may be used in accordance with one or more embodiments of the present technology;

FIGS. 18A and 18B are examples of graphical user interfaces on a mobile device that may be used in accordance with one or more embodiments of the present technology;

FIGS. 19A, 19B, 19C, 19D, and 19E are examples of graphical user interfaces on a mobile device that may be used in accordance with one or more embodiments of the present technology;

FIG. 20 is an example of graphical user interfaces on a mobile device that may be used in accordance with one or more embodiments of the present technology;

FIGS. 21A and 21B are examples of graphical user interfaces on a mobile device that may be used in accordance with one or more embodiments of the present technology; and

FIG. 22 is an example of a computer system in which various embodiments of the present technology may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to real-estate service management system. The system and method are useful for buyers, agents, realtors, vendors, and financial institutions involved in the transaction and maintenance of a real-estate property. More specifically, some embodiments of the present technology relate to platforms for sharing, modifying, automating, and scheduling real-estate content. Real-estate content including client property data, third-party data, home property contracts, and the like may be pulled from cloud-based data storage.

Various embodiments of the cloud-based real-estate property service management system integrate a number of users in different roles performing different activities. At the highest level, the roles of these users can be divided into a transaction management phase and a client engagement phase. During the transaction management phase, agents may upload a document in a folder that shares access with other parties (e.g., financial institutions, realtors, and listing agents). Each user with access to that document is tasked with managing an aspect of that document. While the goal is to thoroughly review the contents of the document, one party may only be able to complete a task subsequent to the first party finishing a first task. For task may include, for example, a lender approving a home loan amount prior to the home buyer signing the purchase agreement.

The home buying process involves many parties. However, the difficulty arises when transaction resources pull agents in multiple directions. Agents are thus ineffectively assisting client's complete transactions. Developing a system that helps direct all the real-estate interactions to one platform would expedite the closing of a deal. Moreover, the streamline platform would safeguard the relationships built between the agents and clients. Offering an automated communication solution would further reduce challenges exposed to agents.

Given the complexity of task prioritization assigned to various parties, various embodiments provide for management of tasks with content such as documents retrieved from a cloud database. The documents may include contract contingencies that require the agent to implement best practice. In order for the agent to achieve best practices such as reminding the customer to bring their earnest money, agents must stay interconnected with client through automated task generation. Because both the client and the agent have access to a shared folder containing the document, tasks can be automatically generated. Tasks may be generated in some embodiments based on the role defined by the user. The arrangement of the tasks may be dependent on the identified role of the user. Depending on the complexity of the document, task timelines may include review or processing from other parties. One or more tasks may be generated for each user. Keeping each user on track is often difficult and time consuming for the agent. However, once a document is uploaded and shared in a cloud accessible location, the automatic task generation streamlines the process for completing any document.

Some embodiments of the present technology provide for EZ tasks. Facilitating real-estate transactions may become complex cases. However, automated processing of tasks reduces the time delay of transactions between users. The automated process in various embodiments utilize an engine that connects transactions with task scheduling. EZ tasks can further simplify tasks comprising multiple steps. For example, an agent may need to draft an email to a closing agency. Various embodiments of the present technology prompt the agent with a notification or recommendation to generate an email to the closing agency. Following the agent's confirmation, an email can be prepopulated with data and sent to corresponding recipients. A final prompt maybe surfaced in some embodiments requesting a confirmation to send. Another example of an EZ task is generating a birthday reminder for a client. After a prompt to the agent, an EZ task may automatically collect client details and send a message. Task functionalities that typically require many steps may be compiled into an EZ task. Proactive intelligence such as EZ task is driven by an operational engine.

Various embodiments can also help agents in maintaining client relationships after a home purchase. Even though home buyers may be satisfied with the real-estate agent, clients often pursue other agent for future home purchases. The infrequency of home purchasing transactions contributes to agent and client relationship degradation. Agents often build a significant portion of their client portfolio based on referrals. However, preserving converted referral relationships require time consuming effort from the agent. For example, a couple purchases a home using an agent, but ten years have passed since they used the agent. The couple proceeds to seek other agents for a new home purchase.

In order to proceed with the engagement management phase, various embodiments of the present technology assist an agent in initiate a new transaction connecting both the agent user and the client user. Subsequent to the connection, data from a 3^{rd} party property or real-estate database can be automatically populated in various embodiments. The populated data can be determined by metadata extracted from the client user such as home property details. For example, the home property details can be processed against a maintenance repair database that compares property features such as a roof, septic, well, etc. The property features can be associated with a timeline recommending various services.

In some embodiments, the home property data can be compared with the home features and service expectancy. If a match results, then a recommendation to the client user will surface. For example, a cedar shake roof may need repairs every 15-20 years. Using metadata information and defining the trigger as “cedar shake,” the client user may receive an automatically generated recommendation on the user dashboard. An example of the recommendation could read, “As our records indicate your home is 20 years old and you have a cedar shake roof and cedar shake roofs have an average life expectancy of 15-20 years. We recommend that you have your roof inspected and treated or replaced to preserve the value and structure of your home. Here are some trustworthy licensed roofing companies that I and the Home Hub Network recommend for you:”

Some embodiments can access a vendor database an include information with one or more recommended vendor to the trigger. The recommendation may also include service provider suggestions and information. Because client user information is stored in a database, home property information may be imported from a 3^{rd} party database. The populated data may include home specific maintenance and replacement expectancy recommendations. The cloud-based property service management platform offers continuous connectivity between the client and the agent, thus, maintaining the engagement between client and agent beyond the transaction of the home.

Various embodiments of the present technology provide a cloud-based property service platform that provides task prioritization and user connectivity in a real-estate environment. In accordance with various embodiments, the real-estate service platform can manage high volume transactions. Each transaction may comprise intricate nuances unique to each client. In addition, agents must coordinate with other agents. Communication with clients, other agent, parties, etc. coupled with overseeing legal documents may become overwhelming. However, a real-estate service platform streamlines all processes. Tasks are distributed in parallel with affiliated users to coordinate real-estate procedures.

Various embodiments of the present technology provide for a wide range of technical effects, advantages, and/or improvements to computing systems and components. For example, various embodiments include one or more of the following technical effects, advantages, and/or improvements: 1) holistic transformation of a transaction and engagement management system that effectively integrates roles of specific users with tasks that are parallel partitioned amongst collaborative users upon the submission of a document in the application; 2) integrated use of a cloud-based property service management platform that allows users to generate custom tasks prioritized uniquely based on the document metadata and affiliated user-role; 3) provide integrated management project lifecycle phases that allow the project to be represented in a consistent way across multiple phases with different users; 4) proactive communication between platform users sharing common content benefit from the process automation of an integrated platform designed with cloud database access and content management capabilities of what has been traditionally inaccessible on a consolidating platform available on a mobile device; 5) use of unconventional and non-routine computer operations to enable custom metadata features such as tags initiate custom notification and recommendation generation to client users from agent users through a multi-touch progression on a user interface; 6) user-specified task functionalities utilize various cloud database such as client, vendor, financial institutions, and 3^{rd} parties, and artificial intelligence to further customize, automate, and populate user-specific action suggestions between users; 7) use of unconventional and non-routine computer operations to dynamically modify user task timetables based on content shared by users and thus receive adjusted recommendations and communications affiliated with the respective user role and shared content metadata; 8) changing the manner in which users can maintain connectivity and access shared or individual content accessed by secure cloud storage; 9) automatic processing of EZ task capabilities corresponding to user-specific work flow based on best practices; and/or 10) changing the manner in which a platform streamlines transaction and content management across multiple users and cloud databases driven in part by metadata affiliation.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

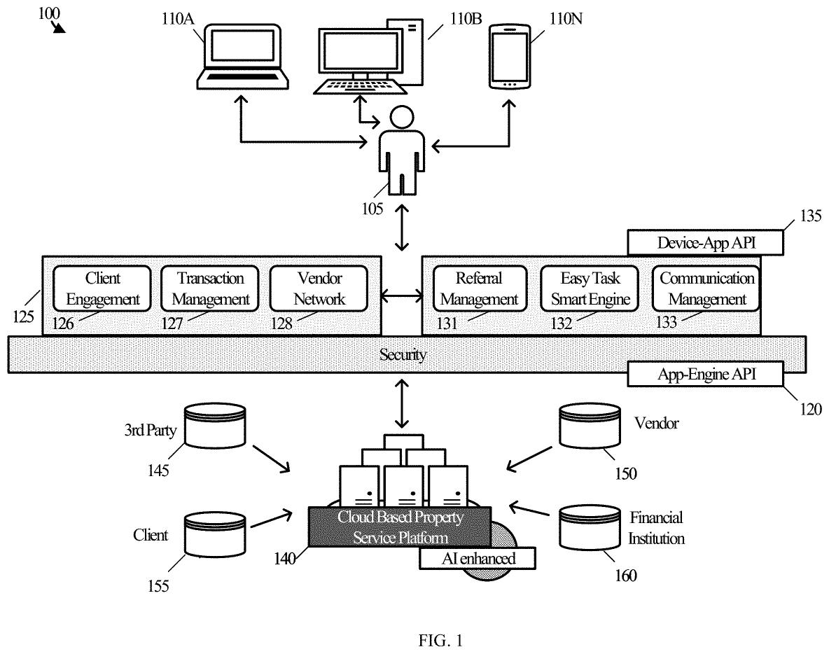

FIG. 1 illustrates an example of an integrated environment in which some embodiments of the present technology may be utilized. In accordance with various embodiments, integrated environment 100 can provide a customized portal experience using cloud-based databases. The integrated environment 100 can provide a customized user experience based on readily access information from any domain, including live transactional data flowing from 3^{rd} parties, client data, financial institution data, and vendor data, to name just a few.

As illustrated in FIG. 1, integrated environment 100 may include one or more computing devices 110A-110N (such as a mobile phone, tablet, computer, etc.). The computing devices 110A-110N can connect (e.g., via device application API 135) with applications and tools 125 which can connect (e.g., via app-engine API 120) to cloud-based property service platform 140. An intermediate layer involves the applications and tools 125 and can support user interactions with applications and tools. The applications and tools 125 can interface with the cloud-based property service platform 140 to take advantage of its artificial intelligence capabilities.

At the user experience layer, agents and clients can interface with a portal in the usual ways, e.g. in the context of web browsers and application interfaces. Integrated security capabilities will span all layers across the user experience layer and through the applications and tools, to the cloud-based property service platform 140.

Computing devices 110A-110N can include network communication components that enable the mobile devices to communicate with remote servers (e.g., hosting the applications and tools 125, etc.) or other portable electronic devices by transmitting and receiving wireless signals using licensed, semi-licensed or unlicensed spectrum over a communications network. In some cases, communication network may be comprised of multiple networks, even multiple heterogeneous networks, such as one or more border networks, voice networks, broadband networks, service provider networks, Internet Service Provider (ISP) networks) and interconnected via gateways operable to facilitate communications between and among the various networks. The communications network can also include third-party communications networks.

Applications and tools 125 can include software that is useful for creating, building, and managing real estate serving managing systems. For example, as illustrated in FIG. 1, applications and tools 125 can include a client engagement module 126, a transaction management module 127, and a vendor network module 128. Other embodiments may include different and/or additional applications such as but not limited to task management tools, user experience tools, and the like. Applications and tools 125 and can be used by agents and clients to automatically suggest tasks, generate communications, and otherwise facilitate interactions between users and real-estate property. In some embodiments, applications and tools 125 can utilize a specialized API 120 for interfacing with the cloud-based property service platform 140. API 120 can enable the applications and tools 125 to call into the resources of the cloud-based property service platform 140, including its artificial intelligence capabilities.

The artificial intelligence can be used to improve the user experience. For example, the end-to-end user experience in some embodiments will allow for various personalization layers that differ based on who a user is, the user's role within a transaction, organization, vendors, and other factors. As a user engages with the applications and tools 125, the user's experience can be customized based on these factors. Different workflows, different data streams, and/or different features and functionality can be exposed to the user based on their profile and interactions.

In accordance with various embodiments, cloud-based service platform 140 supplements the personalized user experience by surfacing recommendations to end users in the context of their workflow. In some embodiments, compute engine 140 can recommend maintenance repairs, greetings, servicing suggestions, and communication generation. Cloud-based property service platform 140 may also be configured to access past home property features, client property details, and vendors across a spectrum of users and deployments to optimize a user's interconnectivity for its current context.

In some embodiments, cloud-based property service platform 140, in conjunction with applications and tools 125, can accelerate the transactional management and client engagement process for end users. Cloud-based property service platform 140 can generate tasks on an analysis of shared documents amongst specific users. In addition, task prioritization is based on the user role and intermittent processes tasked to agents (or other parties), such as approvals, review, signings, or updates. The cloud-based property service platform 140 can use an EZ task engine to automatically compile task procedures for user. The EZ task engine within cloud-based property service platform 140 also accesses client data sets 156 from a wide range of contexts to arrive at task generation design for a given context. In addition, 3^{rd} party data 145, vendor data 150, financial institutions 160, and the like can also be used cloud-based property service platform 140 to create customized user experiences and recommendations.

It may be appreciated that in one or more embodiments of the present disclosure, that the service platform described herein may generate real estate transaction management and home service management recommendations to users. In some embodiments, the service platform has the ability to complete prescribed tasks directly from a user dashboard with one click opening up in personal email client with specific templates directly referencing at least one task and pre-addressed to appropriate stakeholders within transaction for that specific task. Additional functionality may include the ability to create customizable EZ tasks by a user to create personalized tasks and convert one or more personalized tasks to an EZ task including automated stakeholder email addressing within the customized EZ task.

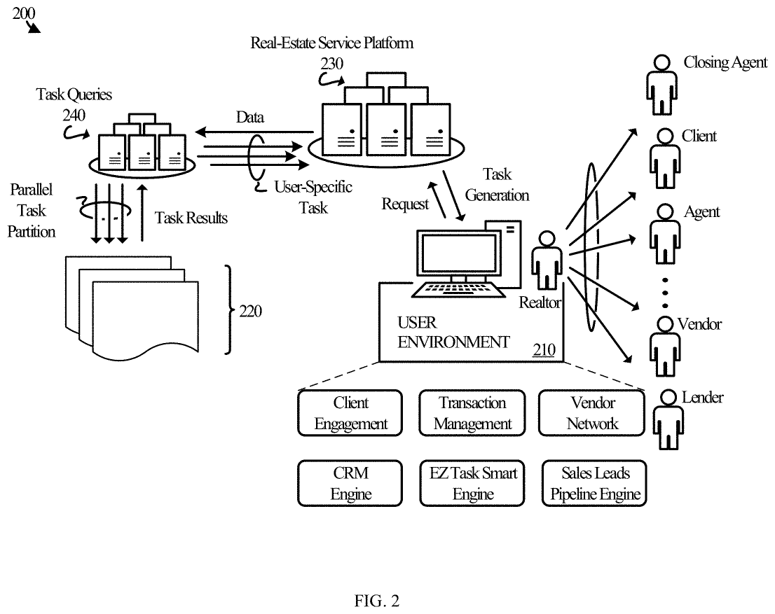

FIG. 2 illustrates data flow between various components of an integrated platform that may be used in one or more embodiments of the present technology. As illustrated in FIG. 2, a user can access user environment 210 to access one or more applications or tools for transaction management or client engagement. The user can have different roles and interact with other users or vendors. For example, in a transaction management phase, a client can reference details of their home purchase through transaction management. During a client engagement phase, a realtor can utilize CRM engine to send articles to clients. Similarly, an agent may utilize EZ task to generate communications to other agents.

User environment 210 can make request to integrated platform to run multiple applications based on a common data file 220. In accordance with various embodiments, real-estate service platform 230 receives a request in a transaction management phase. A document is uploaded to a shared location with one or more users. The contents of the document are analyzed for metadata and associated to roles of each user. The metadata can be submitted to task queries 240. The task queries match tasks that are assigned to each document type. The tasks are partitioned in parallel for each user role. The results of the task partition are sequentially organized for each user. The user-specific tasks are returned for review in the dashboard.

The user environment can request data from real-estate service platform 230. Real-estate service platform 230 can make one or more queries to task query to access the underlying tasks 220 for the document. Tasks 220 are determined based on the document and users who have access to that document. The need for different tasks (e.g., review, approve, sign, etc.) can be holistically determined by the shared document. In some embodiments, as the results are returned from task queries 240, tasks 220 are ordered in a user timetable in parallel with other user timetables by real-estate service platform 230 so that the tools and applications within user environment 210 can present the tasks according to the role of the user.

Real-estate service platform 230 can also analyze the data (e.g., using artificial intelligence) from multiple users, vendors, and roles to generate an enhanced or user experience within user environment 210. For example, in a transactional management phase, real-estate service platform 230 can generate communications from agents to clients based on the tags associated with client user profiles. In addition, recommendations, suggestions, task generations, communications, and the like may also be automatically surfaced to influence the user's experience and selection. As another example, the tools and applications may update (e.g., periodically or in real-time) tasks and updates on the dashboard for review by the user. The user integration capabilities provided by real-estate service platform 230, in some embodiments, can help the user ensure every user or party involved in the transaction or engagement are efficiently and effectively connected.

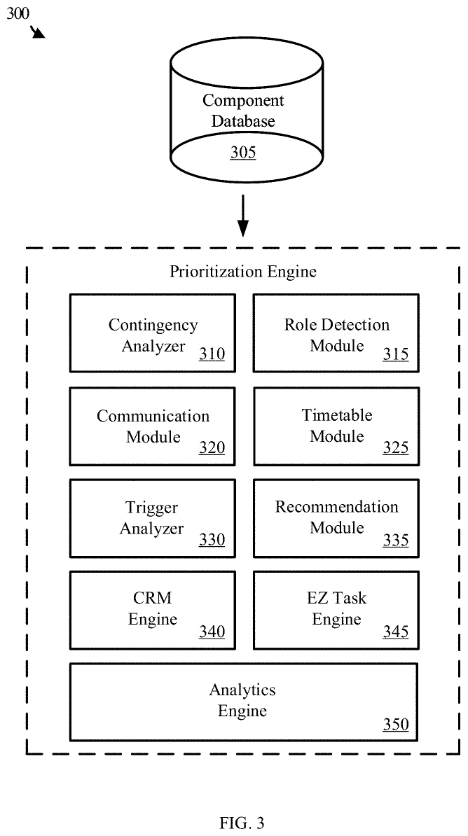

FIG. 3 illustrates a set of components 300 that may be used within an integrated platform according to one or more embodiments of the present technology. According to the embodiments shown in FIG. 3, integrated platform can include component database 305, contingency analyzer 310, role detection module 315, communication module 320, timetable module 325, trigger analyzer 330, recommendation module 335, CRM engine 340, EZ task engine 345, and analytics engine 350. Each of these modules can be embodied as special-purpose components to the operation of the real-estate service platform. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, recommendation module 335, communication module 320, and EZ Task Engine 345 can be combined into a single module for presenting an enhanced customized experience to a user.

Contingency Analyzer 320 can identify the metadata of contracts that reflect specific details unique to the document. The document is compared to a database of contingencies that are paired with various user roles. Role detection module 315 identifies the role of the user and assigns tasks specific to each user corresponding to the role. Communication module 320 compiles various forms of correspondences such as emails. The emails may also comprise details from both the initiating user such as the agent and the receiving user such as the client. Timetable Module 325 includes fields that pertain to user tasks and information. Trigger analyzer 330 compares home features against home property data to find a match. Following a match, service expectancies are analyzed for a match. Recommendation module 335 offers a prompt or suggestion to users to generate a communication following periodic analysis of client data. In some embodiments, recommendation module 335 may fill various communications such as emails with data. CRM engine 340 combines touch and swipe capabilities of user interactions of documents and facilitates the distribution with other users. EZ task engine 345 compiles a sequence of tasks and consolidates the procedures of the tasks for the users. EZ tasks are accessible on the dashboard of the user.

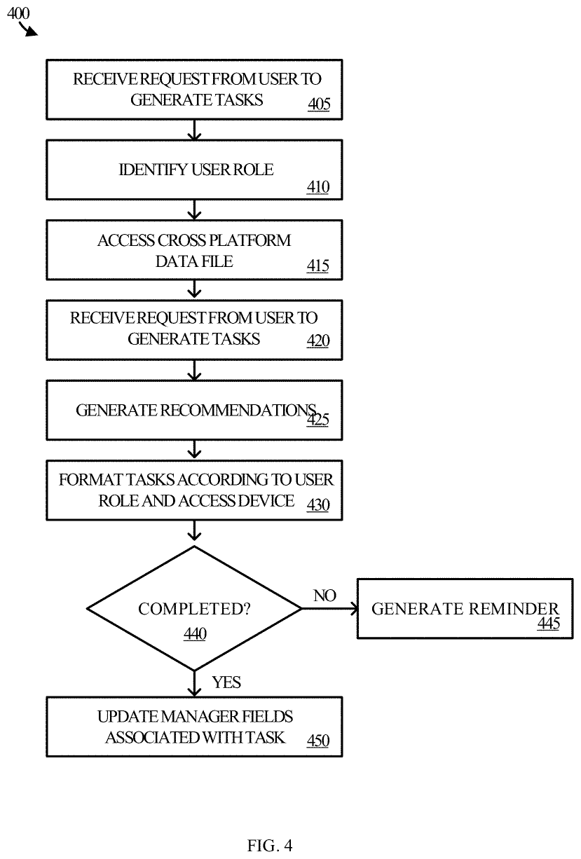

FIG. 4 is a flowchart illustrating a set of operations in environment 400 for managing a customized user experience according to one or more embodiments of the present technology. At requisition step 405, a request is received from a user wherein the request pertains to one or more tasks associated with the user. Based on the user, the user's role may be identified in identification step 410. Next, in access step 415, the user environment may obtain access to a cross-platform data file. The contents of the data file may be analyzed for metadata and associated to roles of each user. The metadata can be submitted to generate tasks at task generation step 420. The task queries match tasks that are assigned to each document type. The tasks are partitioned in parallel for each user role, and the results of the task partition are sequentially organized for each user. The user-specific tasks and recommendations based on this information, in step 425, are returned for review in the dashboard as shown in formatting step 430. If the task list is marked complete at step 440, the user environment may update manager fields associated with the task as shown in update step 450. Alternatively, if the one or more tasks are not complete by the user, the user environment may generate a reminder in step 445.

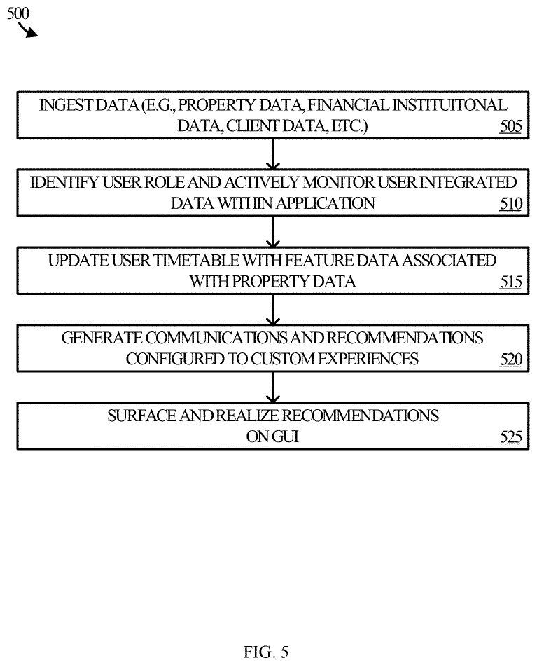

FIG. 5 is a flowchart illustrating a set of operations in environment 500 for generating custom recommendations and user experiences within a property service platform in accordance with some embodiments of the present technology. At initial ingestion step 505, the service platform may intake various data related to property, financials, clients and vendors and the like. When a user enters the service platform, the service platform may identify the user's role at identification step 510. In this step, the service platform may monitor a user's activity to associate data with that user and the user role. Next, in update step 515, the service platform may update a user's timetable with featured data collected after monitoring the user's activity from the previous step. Thus, the service platform can generate communications and recommendations to fit the user's role and activities as shown in configuration step 520. Finally, the service platform renders such communications and recommendations on the graphical user interface to the user device in realization step 525.

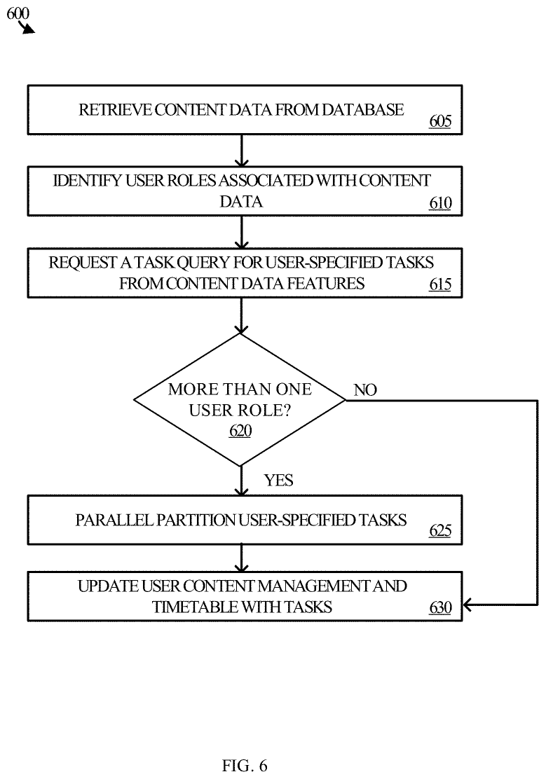

FIG. 6 is a flowchart illustrating a set of operations in environment 600 for automatically partitioning tasks driven by task queries with database inputs according to some embodiments of the present technology. In order to begin partitioning tasks, service platform may retrieve content data from a database in step 605. In some embodiments, the database may be remote or cloud-based, and in others, it may be local to the service platform. Using the content retrieved in step 605, the service platform identifies user roles associated with that particular data in step 610. Still using the content data from the database, the service platform, in step 615, may request a task query for user-specified tasks based on the content data features. If the service platform determines that more than one user role exists in the content data, it can partition the user-specified tasks in parallel. Following the parallel partition step in 625, the service platform may update the user content and user timetable with tasks identified as shown in step 630. Contrarily, if the service platform does not identify more than one user role in step 620, the service platform may skip parallel partitioning step 625 and simply update the user environment with associated tasks.

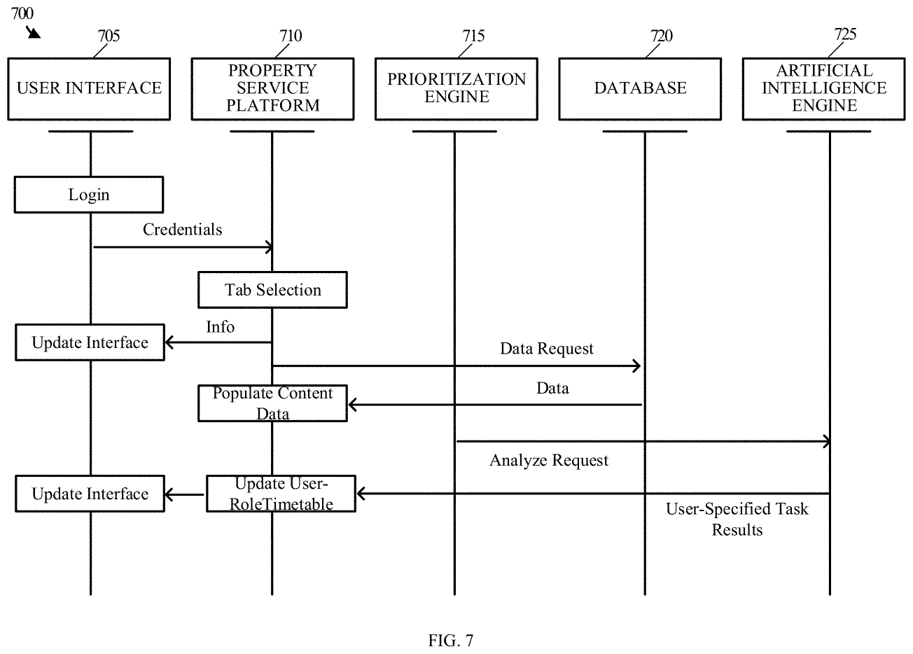

FIG. 7 is a sequence diagram illustrating an example of the data flow between various components of a property service platform according to various embodiments of the present technology. Environment 700 illustrated in FIG. 7 includes user interface 705, property service platform 710, prioritization engine 715, database 720, and artificial intelligence (AI) engine 725. Environment 700 functions to provide a user with a graphical user interface comprising updated data specific to the user's role, activities, requests, and the like.

In some embodiments, a user begins the login process at user interface 705 wherein the user's login credentials are sent and verified by the property service platform 710. While logged into property service platform 710, a user may select a tab that renders a view from the property service platform 710 to user interface 705. On a tab or page view of the property service platform 710, the user may submit a request for data, such as tasks, communications, or the like. Upon data request, property service platform 710 queries database 720, which sends the requested data back to property service platform 710. Meanwhile, prioritization engine 715 may analyze the request sent from property service platform 710 querying AI engine 725 to determine any user-specified task results from data maintained while monitoring the user's activities. Then, AI engine 725 may send any user-specified task results to property service platform 710 to update the user-role timetable. Using both the updated user-role timetable from AI engine 725 and content data provided from database 720, property service platform 710 updates the user interface 705 to the user device.

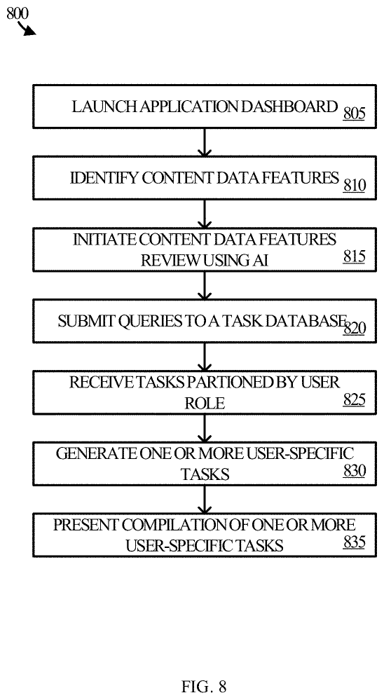

FIG. 8 is a flowchart illustrating a set of operations for presenting tasks in a user interface driven by task queries with database inputs according to some embodiments of the present technology. FIG. 8 encompasses environment 800 which functions to automatically partition tasks driven by task queries with database inputs to present a graphical user interface to a user.

At initial launch step 805, a user may enter a user interface of a service platform in a user device. The service platform, using the user login credentials, may identify a user type or role in order to identify content data features associated with the user role. The service platform obtains this content data from a database in step 810. During the data retrieval stage, the service platform may also query an artificial intelligence engine, in step 815, that may review the content data features to determine any user-specific data. At submission step 820, the service platform may submit task queries to the database. In some embodiments, the service platform may receive information about the tasks from both the AI engine and the database. At step 825, the service platform partitions the tasks received by the user role. Then, the service platform may generate one or more user-specific tasks as shown in step 830. At step 835, the user-specific tasks are rendered in a user interface of the service platform for the user to view the one or more tasks associated with the user's role.

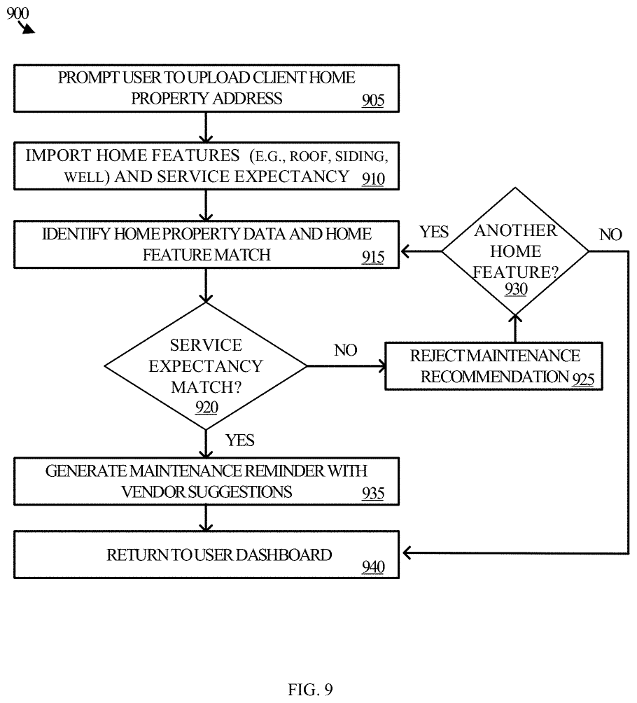

FIG. 9 is a flowchart illustrating a set of operations in environment 900 for automatically surfacing recommendations to users based on home property details and home features and service expectancies in accordance with various embodiments of the present technology. At upload step 905, a property service platform may prompt a user via a user interface to a user device to upload a client home property address. In the next step 910, the user may also import home features corresponding to the client home, such as roofing features, siding features, and the like, and service expectancy. In some embodiments, home features and the like may be imported from a third-party database. Using the imported data, the property service platform may identify a match in step 915. If the service expectancy input matches data in the service platform, at step 920, the property service platform may generate a maintenance reminder with vendor suggestions to provide the services, as shown in step 935. If, however, no service expectancy match exists, the user may reject a maintenance recommendation at step 925 and either continue to add another home feature at step 930 to find a potential match or return to the user dashboard in the user interface, ending the process at step 940.

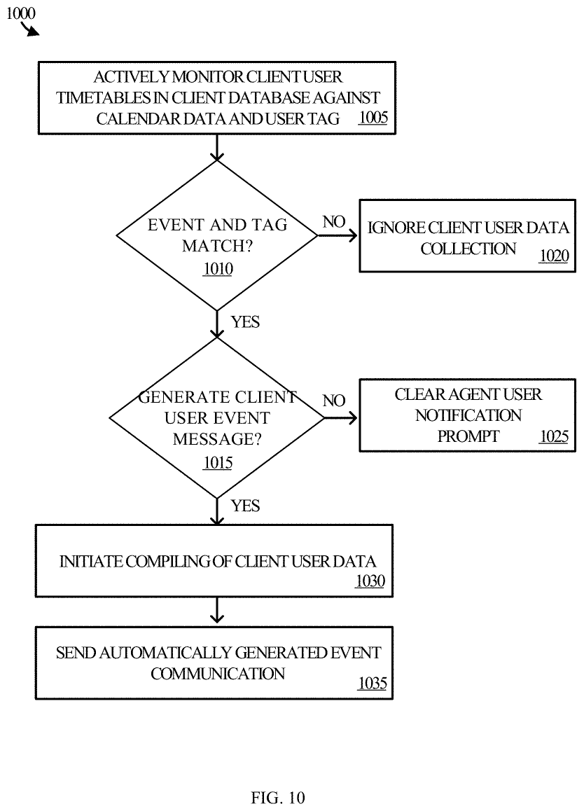

FIG. 10 is a flowchart illustrating a set of operations in environment 1000 for providing expert support for a user in accordance with one or more embodiments of the present technology. Environment 1000 may operate using an artificial intelligence (AI) engine. In some embodiments, the AI engine may actively monitor client user timetables in a client database and compare the activity against calendar data and user tags, such as is exemplified in step 1005. At step 1010, if an event in the client user timetable and a user tag match, the AI engine may send data to the property service platform to generate a client user event message. Once a user event message has been generated at step 1015, the property service platform may begin compiling client user data, as shown in compilation step 1030. Then, at step 1035, the property service platform may automatically send the user a generated event communication.

Still referring to FIG. 10, if, at step 1015, the user does not wish to generate a client user event message, the property service platform may clear an agent user notification prompt at clearing step 1025. Likewise, if, at step 1010, the event in the client user timetable and the user tag do not match, the client user data collection being monitored may be ignored, and the process will end there.

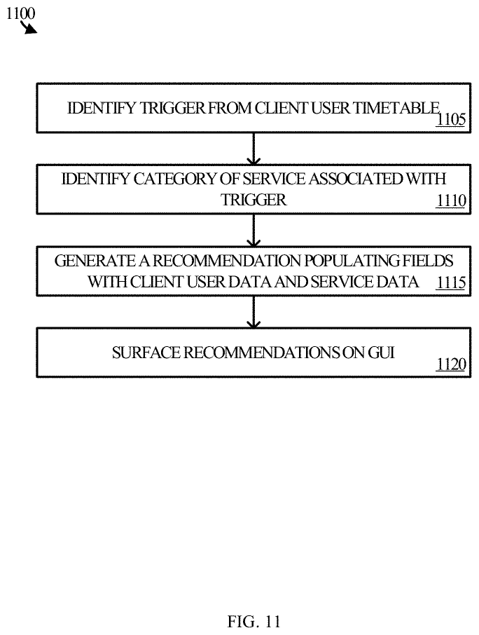

FIG. 11 is a flowchart illustrating a set of operations in environment 1100 for automatically surfacing recommendations to users based on triggers found in client user timetables in accordance with various embodiments of the present technology. At trigger identification step 1105, the property service platform may identify at least one trigger from a client user timetable associated with the client property. For example, a cedar shake roof may need repairs every 15-20 years. The property service platform may use define the trigger as “cedar shake.” At categorization step 1110, the property service platform may categorize the type of service associated with the trigger. In the above example, the category may be denoted as “roofing.” At recommendation step 1115, the property service platform may generate a recommendation to the client user with information populated from the client user data and service data. The client user may receive an automatically generated recommendation on the user dashboard. An example of the recommendation could read, “As our records indicate your home is 20 years old and you have a cedar shake roof and cedar shake roofs have an average life expectancy of 15-20 years. We recommend that you have your roof inspected and treated or replaced to preserve the value and structure of your home. Here are some trustworthy licensed roofing companies that I and the Home Hub Network recommend for you.” At rendering step 1120, the recommendation may be surfaced on the user interface to the user's device.

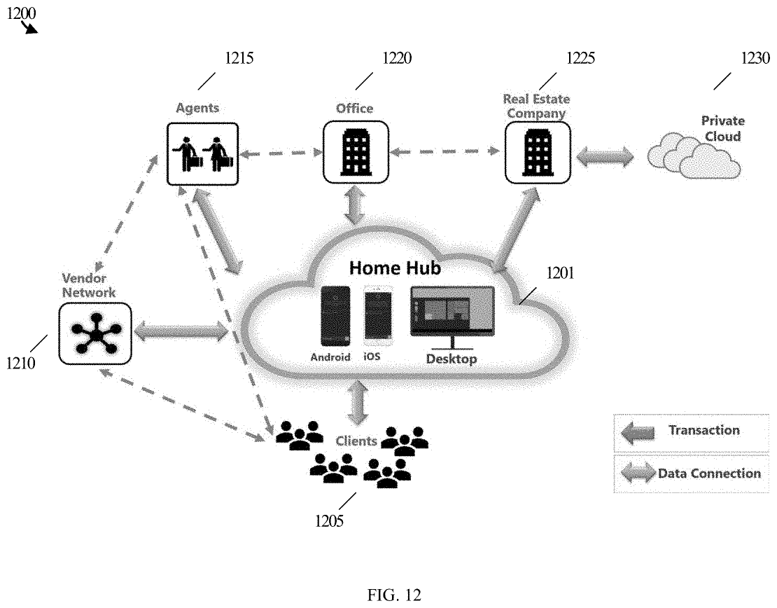

FIG. 12 is a diagram illustrating the network connectivity of a real-estate service management system according to various embodiments of the present technology. Environment 1200 in FIG. 12 includes a property service platform 1201, clients 1205, a vendor network 1210, agents 1215, an office 1220, a real estate company 1225, and a private cloud 1230. In various embodiments, environment 1200 enables sharing, modifying, automating, and scheduling real-estate content. Real-estate content including client property data, third-party data, home property contracts, and the like may be pulled from at least one location, whether cloud-based or local, to provide users the content on property service platform 1201.

In some embodiments, property service platform 1201 may have data connections with each of clients 1205, vendor network 1210, agents 1215, office 1220, and real estate company 1225. Each of the data connections may allow the property service platform to transmit and receive information about clients 1205, agents 1215 and their associated tasks, for example, and various properties and data about the property.

Separately from property service platform 1201, each of the other entities in environment 1200 may transact between each other. For example, in some embodiments, clients 1205 may interact and transact with vendor network 1210 and agents 1215. Likewise, agents 1215 may interact and transact with vendor network 1210 and office 1220. Office 1220 may host transactions with real estate company 1225 who then stores data in private cloud 1230. Property service platform 1201 may then connect with any of the other entities to obtain transaction data to complete processes disclosed herein.

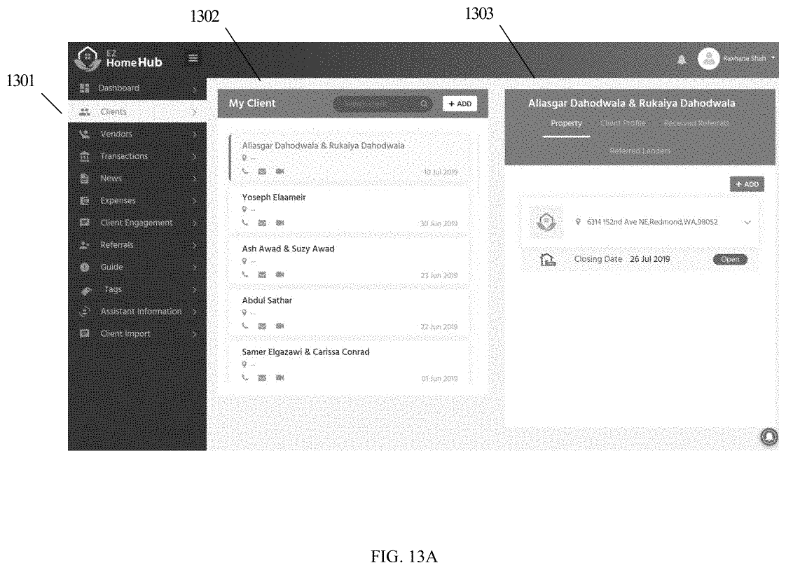

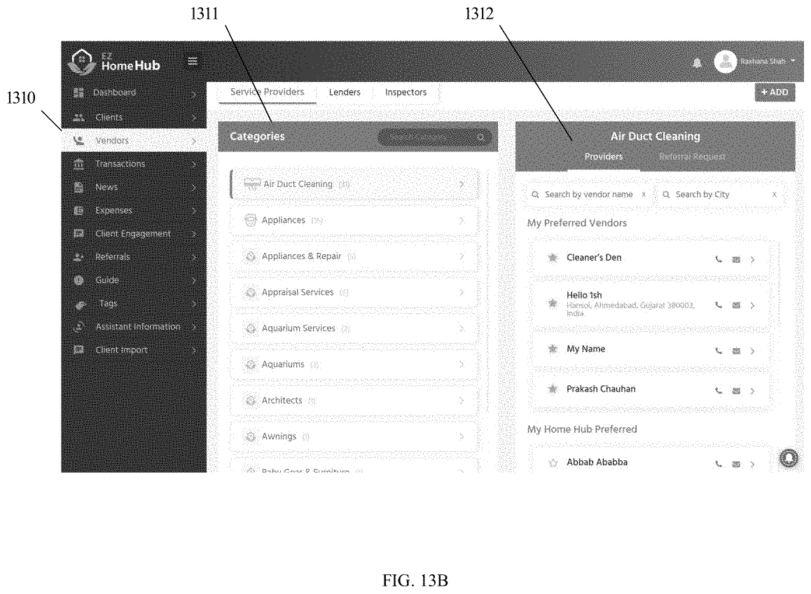

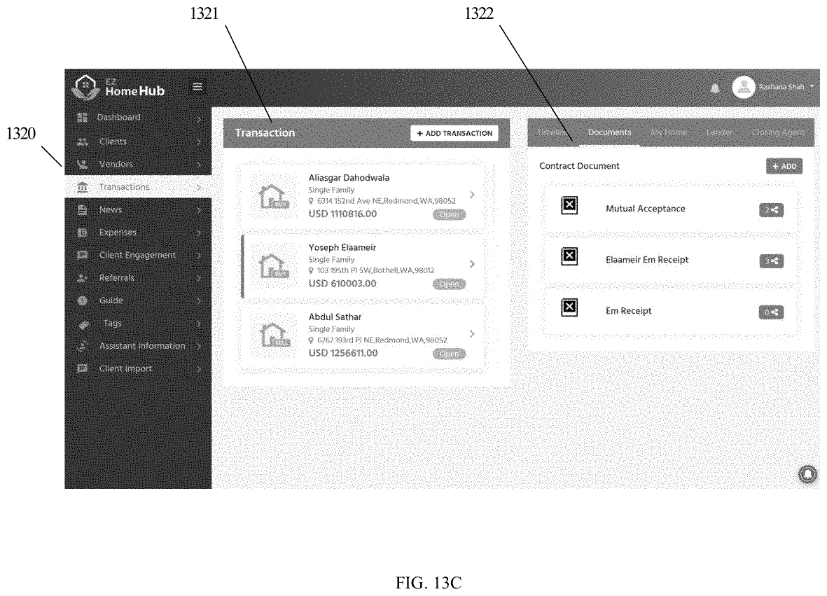

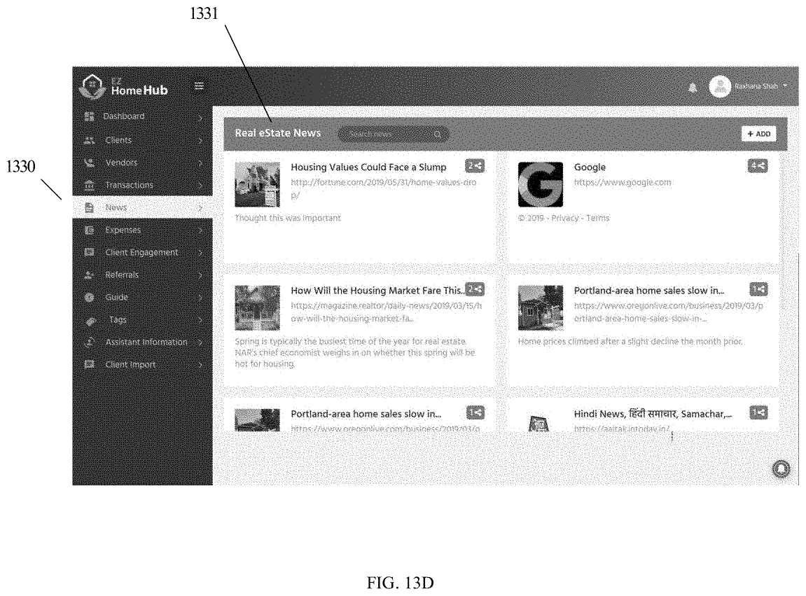

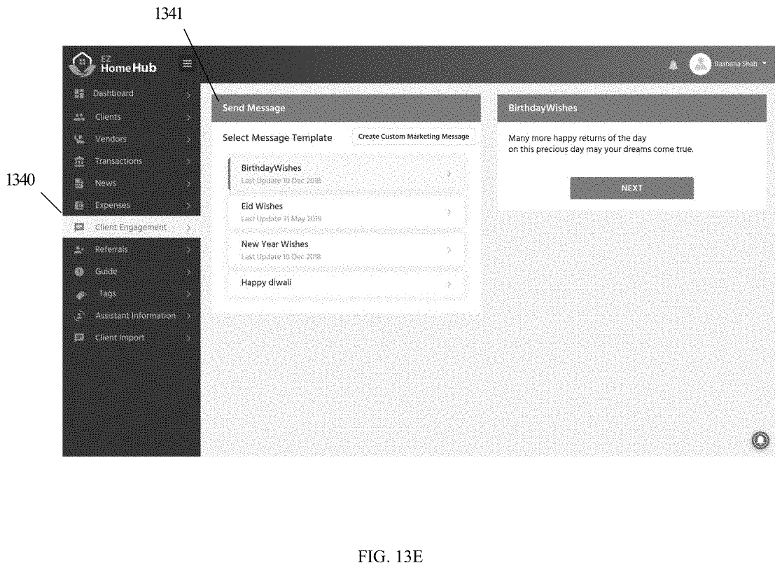

FIGS. 13A, 13B, 13C, 13D, and 13E are examples of graphical user interfaces that may be used in accordance with one or more embodiments of the present technology. Each figure embodies a graphical user interface that may be displayed in a property service platform in various embodiments.

FIG. 13A demonstrates clients tab 1301 that may be included in a graphical user interface in some embodiments of the present disclosure. Clients tab 1301 comprises a list of an agent's clients, client list 1302, and drills down into client details 1303. While operating in the property service platform on clients tab 1301, a real estate agent may search or add new clients to client list 1302. Existing clients appearing on clients tab 1301 may have location information, contact information, and a name associated with the client data.

Additionally, the agent may view details pertaining to a specific client on client list 1302. For example, by way of a click, touch, or the like on the graphical user interface, client details 1303 may surface presenting information such as property details, tasks, maintenance requests, client profile information, and the like. An agent may also add further information to a specific client profile or property within client details 1303.

Turning to FIG. 13B, this demonstrates vendors tab 1310 that may be included in a graphical user interface in some embodiments of the present disclosure. Vendors tab 1310 may include a vendor category list 1311 with further information on a vendor category detail list 1312. A user may enter vendor tab 1310 to contact a specific vendor as a result of required service to a property. Vendor category list 1311 includes a list of maintenance or service categories based on the type of service offered, such as appliances, air duct cleaning, plumbing, and the like. Vendor category list 1311 may also include lenders and/or inspectors in addition to service providers.

In some embodiments, a user may click or tap on a specific service category from vendor category list 1311. Then, the property service platform may present a list of vendors and their contact information in vendor category detail list 1312. Such information on vendor category detail list 1312 may include, but is not limited to, a vendor name, a vendor address, and vendor contact information. A user may also be able to choose specific vendors as preferred for future reference and filtered viewing. A user may be able to search for a specific vendor by name or by a city where property is located in to further filter the list.

Moving to FIG. 13C, this demonstrates a transactions tab 1320 that may be included in a graphical user interface in some embodiments of the present disclosure. Transactions tab 1320 includes transaction list 1321 and transaction details 1322. Within transaction tab 1320, a user may add, view, or open details on specific transactions. Transactions in transaction list 1321 may include, as an example, service charges or property payments, among other things. A user may navigate from transaction list 1321 to transaction details 1322 to view information such as receipts, contracts, and the like. Transaction data can be populated by user role or a specific user. Alternatively, the property service platform may obtain transaction data from a cloud-based storage, a local database, or a third-party database where transactions occurred outside of the property service platform, for example.

Next, FIG. 13D demonstrates news tab 1330 that may be included in a graphical user interface in some embodiments of the present disclosure. News tab 1330 may display real estate news articles and links to third party websites, as shown in news listing 1331. The links and articles contained in news listing 1331 may be tailored to a user type or role or a specific user based on behavior monitored by an artificial intelligence (AI) engine. The AI engine may monitor content data features and transactions performed by the user to determine relevant news and prompt the property service platform to display specific content. Alternatively, in some embodiments, the news listing 1331 may be set by the user, a manager or company, or the like.

FIG. 13E demonstrates client engagement tab 1340 that may be included in a graphical user interface in some embodiments of the present disclosure. Client engagement tab 1340 includes message board 1341 where a user can interact with other users of the property service platform. The messages may be selected from a template or, alternatively, the user can create a custom marketing message to send to clients or other agents, for example. In some embodiments, a user may also view received messages from other users of the property service platform in client engagement tab 1340.

Aspects and implementations of the real estate management system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

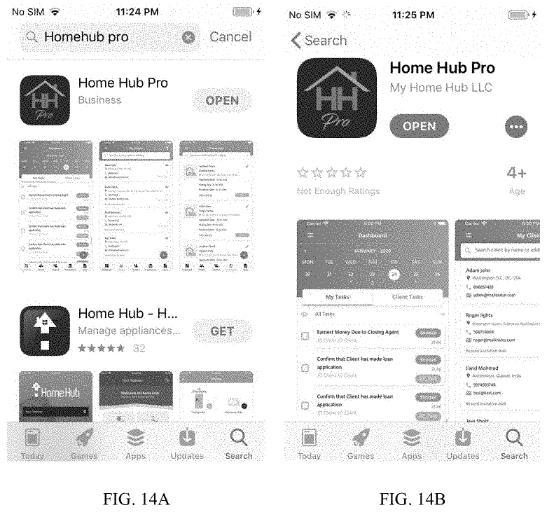

FIGS. 14A and 14B are examples of graphical user interfaces on a mobile device that may be used in accordance with one or more embodiments of the present technology. FIG. 14A demonstrates an example of a search result when entering in the name of a property service platform in an application store on a mobile device. Upon clicking or tapping on the user interface, the mobile device may render a detailed screen providing further information about the property service platform.

FIGS. 15A, 15B, and 15C are examples of graphical user interfaces on a mobile device that may be used in accordance with one or more embodiments of the present technology. FIG. 15A demonstrates an initial log in screen of an application on a user device. In some embodiments, an e-mail address may be used to associate a user with an account on a property service platform. Upon entering correct credentials, the application may demonstrate a loading screen, as shown in FIG. 15B, while the application initializes. Once a user is logged in to the application on the user device, a home dashboard may populate with a list of tabs or screens or the like that the user may navigate to. FIG. 15C illustrates an example of a home dashboard with navigational tabs including, for example, client management, client referral, and more associated with the property service platform.

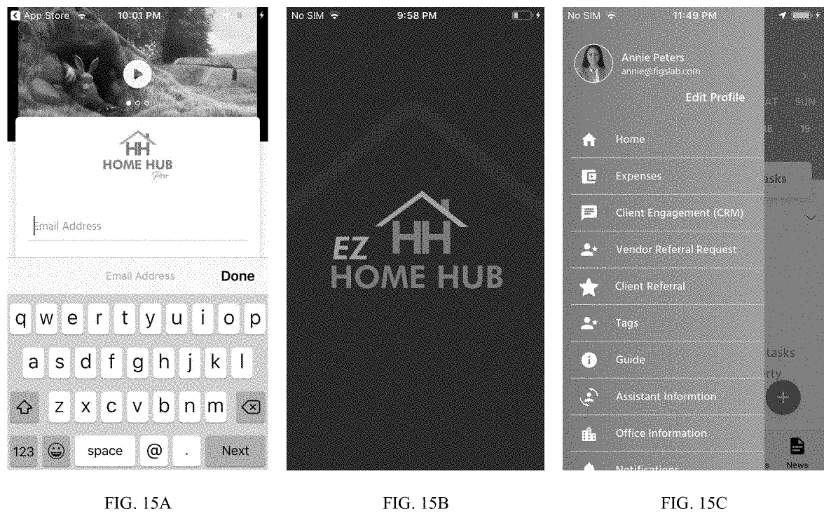

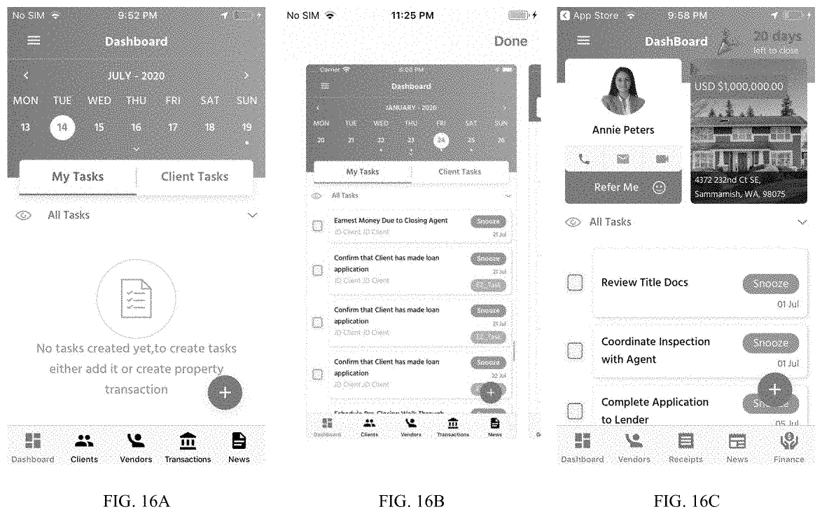

FIGS. 16A, 16B, and 16C are examples of graphical user interfaces on a mobile device that may be used in accordance with one or more embodiments of the present technology. FIG. 16A demonstrates an example view of a dashboard on an application for a property service platform on a user device. This example view shows no tasks assigned to the user for a particular date. Moving to FIG. 16B, however, this view demonstrates a list of user-specific tasks for a calendar day. On the dashboard view, the tasks may be selected by a user to see more details, they may be edited or marked complete, or they may be converted into an EZ task. Additionally, FIG. 16C demonstrates another example dashboard view that may include real estate agent information, property information, and tasks associated with the property. Further tasks may be added to the dashboard view, tasks may be edited, and tasks may be marked complete.

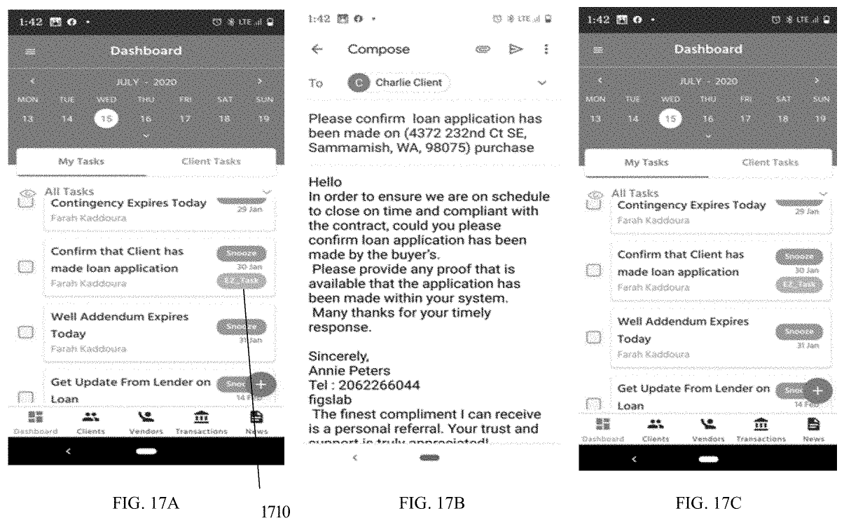

FIGS. 17A, 17B, and 17C are examples of sequential graphical user interfaces on a mobile device that may be used in accordance with one or more embodiments of the present technology. First, FIG. 17A demonstrates an example of a dashboard view in a property service management application on a user device. On the dashboard view, various tasks associated to a user may be listed. There, the user can select EZ button 1710 to convert a task into an EZ task wherein the application will automatically open an e-mail application with a template recommendation message addressed to the associated client, as shown in FIG. 17B. The template recommendation message may obtain information based on the user, the property, home properties, a service expectancy, and the like. The information obtained for the recommendation message may be received from one or more databases. Next, upon sending the recommendation message, the user may be navigated back to the dashboard in the property service application, as shown in FIG. 17C.

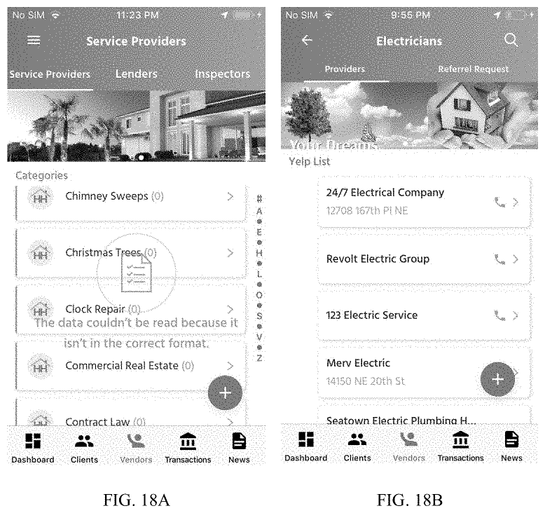

FIGS. 18A and 18B are examples of graphical user interfaces on a mobile device that may be used in accordance with one or more embodiments of the present technology. FIG. 18A demonstrates an example view of vendor dashboard on a property service application on a user device. The vendor dashboard may include a list of categories of service provider vendors, such as chimney sweeps or clock repairmen, for example. Additionally, the vendor dashboard may include similar listings of categories for lenders and inspectors. A user may be able to add further categories to the dashboard.

Next, FIG. 18B demonstrates an example view of a vendor list on a property service application on a user device. From the screen shown in FIG. 18A, a user may navigate to a category of vendor, such as electricians, for example. The application may display a list of service providers in the area of the user for that category of service. A user may navigate further to view details of the vender, such as address or contact information. If the application does not include a specific vender, a user may be able to add a vender under that category. A user may also be able to search for a specific vender using a search bar. A user can also navigate back to the vender dashboard previously described in FIG. 18A.

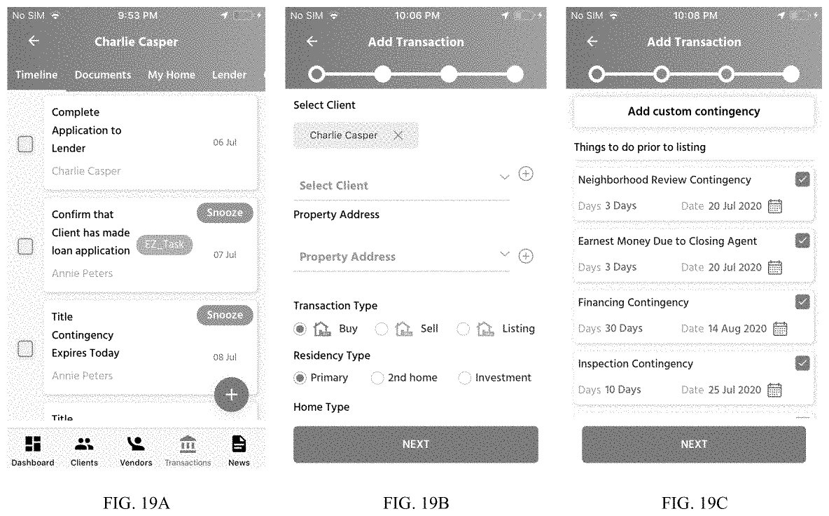

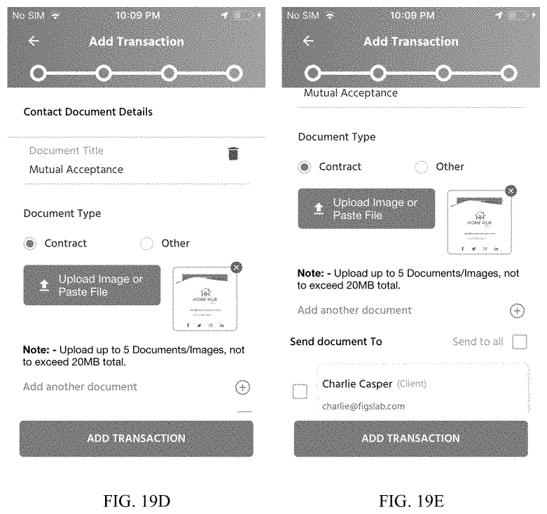

FIGS. 19A, 19B, 19C, 19D, and 19E are examples of graphical user interfaces on a mobile device that may be used in accordance with one or more embodiments of the present technology. Each figure demonstrates an example screen or view on a property service application pertaining to transactions associated with real estate property. FIG. 19A illustrates a transaction timeline view that lists each task associated with a specific transaction. The user may view details of the task, edit or mark the task complete, add new tasks, or convert a task to an EZ task.

Moving to FIG. 19B, this view demonstrates a view for adding a new transaction to the property service application. A user may fill out various fields when adding a new transaction, such as a client associated with the transaction, a property address, a type of transaction, a residency type, a home type and more.

Next, FIG. 19C demonstrates a view where the user can add tasks associated with the transaction, such as things to do prior to listing the property. In some embodiments, the tasks added in this view may be populated in a timeline dashboard after the task is created.

Subsequently, FIGS. 19D and 19E demonstrate a view of finalizing the addition of the new transaction. At this last step, a user may upload any related documents, name the uploaded documents, and send the document to at least one recipient. Upon creation of a new transaction, the transaction may be displayed in both the agent user's application and the client user's application for monitoring and maintaining. The transaction may be stored in a local or remote storage service.

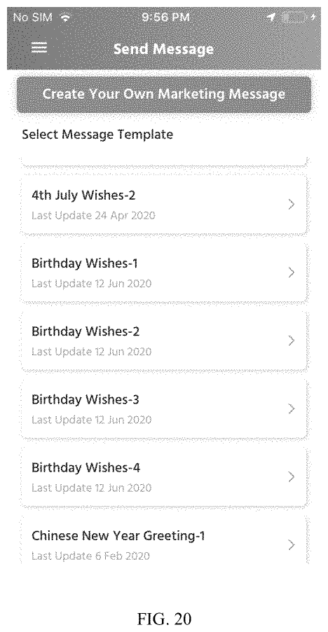

FIG. 20 is an example of graphical user interfaces on a mobile device that may be used in accordance with one or more embodiments of the present technology. FIG. 20 demonstrates an example view of a message dashboard of a property service application on a user device. A user may choose a template message or may create a new message that may be addressed and sent to at least one client or user of the property service application. As an example, a message template may be a happy birthday wish to a client. Clicking or tapping on the message template may open a message application, an e-mail application, or the like to send the message to a chosen client.

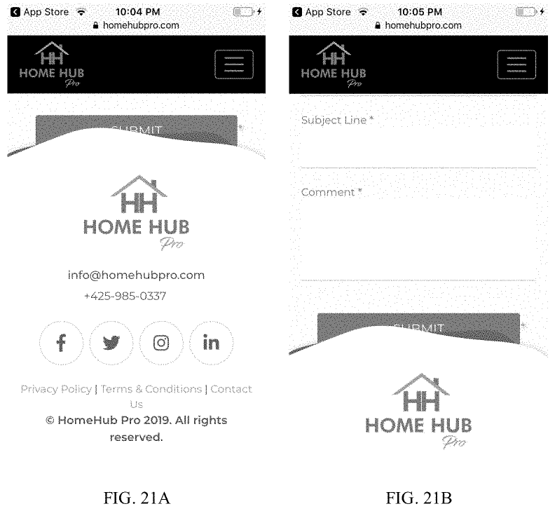

FIGS. 21A and 21B are examples of graphical user interfaces on a mobile device that may be used in accordance with one or more embodiments of the present technology. FIGS. 21A and 21B demonstrate example views of a contact page on a property service application on a user device. The contact page may include an e-mail address, phone number, and various social media links to reach a customer service agent. Additionally, the contact page may allow a user of the application to submit a comment or question to a customer service agent. The contact page may also include links to legal documents, such as terms and conditions and a privacy policy.

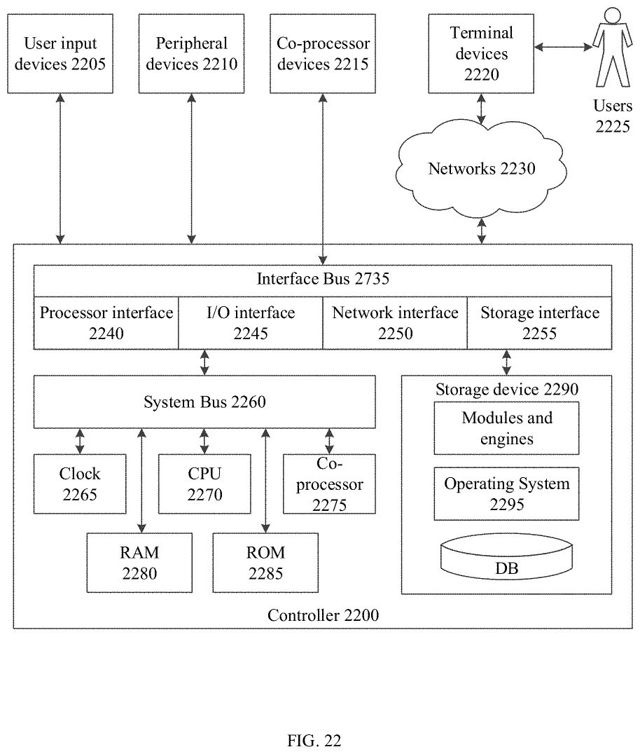

FIG. 22 is a block diagram illustrating an example machine representing the computer systemization of the real estate system. The system controller 2200 may be in communication with entities including one or more users 2225 client/terminal devices 2220 (e.g., devices 110A-110N), user input devices 2205, peripheral devices 2210, an optional co-processor device(s) (e.g., cryptographic processor devices) 2215, and networks 2230. Users may engage with the controller 2200 via terminal devices 2220 over networks 2230.

Computers may employ central processing unit (CPU) or processor to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The controller 2200 may include clock 2265, CPU 2270, memory such as read only memory (ROM) 2285 and random-access memory (RAM) 2280 and co-processor 2275 among others. These controller components may be connected to a system bus 2260, and through the system bus 2260 to an interface bus 2235. Further, user input devices 2205, peripheral devices 2210, co-processor devices 2215, and the like, may be connected through the interface bus 2235 to the system bus 2260. The interface bus 2235 may be connected to a number of interface adapters such as processor interface 2240, input output interfaces (I/O) 2245, network interfaces 2250, storage interfaces 2255, and the like.

Processor interface 2240 may facilitate communication between co-processor devices 2215 and co-processor 2275. In one implementation, processor interface 2240 may expedite encryption and decryption of requests or data. Input output interfaces (I/O) 2245 facilitate communication between user input devices 2205, peripheral devices 2210, co-processor devices 2215, and/or the like and components of the controller 2200 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 2250 may be in communication with the network 930. Through the network 2230, the controller 2200 may be accessible to remote terminal devices 2220. Network interfaces 2250 may use various wired and wireless connection protocols such as, direct connect, Ethernet, wireless connection such as IEEE 802.11a-x, and the like.

Examples of network 2230 include the Internet, Local Area Network (LAN), Metropolitan Area Network (MAN), a Wide Area Network (WAN), wireless network (e.g., using Wireless Application Protocol WAP), a secured custom connection, and the like. The network interfaces 2250 can include a firewall which can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 2255 may be in communication with a number of storage devices such as, storage devices 2290, removable disc devices, and the like. The storage interfaces 2255 may use various connection protocols such as Serial Advanced Technology Attachment (SATA), IEEE 1394, Ethernet, Universal Serial Bus (USB), and the like.

User input devices 2205 and peripheral devices 2210 may be connected to I/O interface 2245 and potentially other interfaces, buses and/or components. User input devices 2205 may include card readers, fingerprint readers, joysticks, keyboards, microphones, mouse, remote controls, retina readers, touch screens, sensors, and/or the like. Peripheral devices 2210 may include antenna, audio devices (e.g., microphone, speakers, etc.), cameras, external processors, communication devices, radio frequency identifiers (RFIDs), scanners, printers, storage devices, transceivers, and/or the like. Co-processor devices 2215 may be connected to the controller 2200 through interface bus 2235, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The controller 2200 may employ various forms of memory including on-chip CPU memory (e.g., registers), RAM 980, ROM 985, and storage devices 2290. Storage devices 2290 may employ any number of tangible, non-transitory storage devices or systems such as fixed or removable magnetic disk drive, an optical drive, solid state memory devices and other processor-readable storage media. Computer-executable instructions stored in the memory may include the real estate platform 140 having one or more program modules such as routines, programs, objects, components, data structures, and so on that perform particular tasks or implement particular abstract data types. For example, the memory may contain operating system (OS) component 2295, modules and other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, stack, structured text file (e.g., XWL), table, and/or the like. Such data-structures may be stored in memory and/or in structured files.

The controller 2200 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 2200 may be distributed electronically over the Internet or over other networks (including wireless networks). Those skilled in the relevant art(s) will recognize that portions of the system may reside on a server computer, while corresponding portions reside on a client computer. Data structures and transmission of data particular to aspects of the controller 2200 are also encompassed within the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of generating real estate service management recommendations, the method comprising:
obtaining home property data from one or more databases, wherein the home property data comprises one or more home features of a plurality of home features and a service expectancy associated with the one or more home features;
identifying one or more triggers based at least on one or more of the home features and the service expectancy;
generating a recommendation associated with the home property data based on at least the one or more triggers;
surfacing the recommendation in a user interface of the property service platform, wherein the recommendation comprises at least the home property data; and
sending a communication, wherein the communication comprises at least the recommendation and a client recipient.

2. The method of claim 1, wherein the communication further comprises at least one or more vendors, service provider information, and a maintenance repair timeline.

3. The method of claim 1, wherein sending the communication further comprises launching an e-mail application using an application programming interface (API).

4. The method of claim 1, wherein the recommendation further comprises a customized task associated with at least the home property data and a user of the property service platform.

5. A computing apparatus comprising:
one or more computer readable storage media;
one or more processors operatively coupled with the one or more computer readable storage media; and
program instructions stored on the one or more computer readable media that, when executed by the one or more processors, direct the computing apparatus to at least:
obtain home property data and user data from one or more databases, wherein the home property data comprises one or more home features of a plurality of home features and a service expectancy associated with the one or more home features;
identify one or more triggers based at least on one or more of the home features and the service expectancy;
generate a recommendation associated with the home property data based on at least the one or more triggers;
surface the recommendation in a user interface of the property service platform, wherein the recommendation comprises at least the home property data; and
send a communication, wherein the communication comprises at least the recommendation and a client recipient.

6. The computing apparatus of claim 5, wherein the communication further comprises at least one or more vendors, service provider information, and a maintenance repair timeline.

7. The computing apparatus of claim 5, wherein to send the communication, the program instructions, when executed by the one or more processors, further direct the computer apparatus to at least launch an e-mail application using an application programming interface (API).

8. The computing apparatus of claim 5, wherein the recommendation further comprises a customized task associated with at least the home property data and a user of the property service platform.

9. One or more computer-readable storage media having program instructions stored thereon to facilitate real estate management tasks, wherein the program instructions, when executed by a computing system, direct the computing system to at least:
obtain home property data from one or more databases, wherein the home property data comprises one or more home features of a plurality of home features and a service expectancy associated with the one or more home features;
identify one or more triggers based at least on one or more of the home features and the service expectancy;
generate a recommendation associated with the home property data based on at least the one or more triggers;
surface the recommendation in a user interface of the property service platform, wherein the recommendation comprises at least the home property data; and
send a communication, wherein the communication comprises at least the recommendation and a client recipient.

10. The one or more computer-readable storage media of claim 9, wherein the communication further comprises at least one or more vendors, service provider information, and a maintenance repair timeline.

11. The one or more computer-readable storage media of claim 9, wherein to send the communication, the program instructions, when executed by the computing system, further direct the computing system to at least launch an e-mail application using an application programming interface (API).

12. The one or more computer-readable storage media of claim 9, wherein the recommendation further comprises a customized task associated with at least the home property data and a user of the property service platform.
